(19) United States
(12) Patent Application Publication
(10) Pub. No.: US 2016/0061269 A1
(43) Pub. Date: Mar. 3, 2016

(54) MANUFACTURER-IDENTIFIABLE BEARING ELEMENT

(71) Applicant: Thomas Krause, Grafenrheinfeld (DE)

(72) Inventor: Thomas Krause, Grafenrheinfeld (DE)

(73) Assignee: AKTIEBOLAGET SKF, Goteborg (SE)

(21) Appl. No.: 14/836,114

(22) Filed: Aug. 26, 2015

(30) Foreign Application Priority Data
Aug. 26, 2014 (DE) 102014216882.1

(51) Int. Cl. F16C 41/00; F16C 33/72; F16C 33/56; F16C 33/20; F16C 33/44

(52) U.S. Cl. CPC F16C 41/008; F16C 33/201; F16C 33/44; F16C 33/56; F16C 33/72

(57) ABSTRACT

A bearing component including plastic is disclosed, which bearing component is manufactured at least partially from a plastic or a plastic compound. The plastic or the plastic compound includes additives, in particular security particles, that are detectable analytically, in particular optically. More specifically, the bearing component includes security particles that are configured to reflect radiation of at specific wavelengths or at wavelengths that are not visible to the human eye—infrared and/or ultraviolet wavelengths, for example.

### CROSS-REFERENCE

This application claims priority to German patent application no. 10 2014 216 882.1 filed on Aug. 26, 2014, the contents of which are fully incorporated herein by reference.

### TECHNOLOGICAL FIELD

The present disclosure is directed to a bearing element, such as a cage for receiving rolling elements of a bearing, or a seal element of a bearing, or a sliding layer of a sliding bearing, which bearing element is manufactured at least partially from a plastic or a plastic compound and includes a security feature.

### BACKGROUND

The potential for counterfeiting is a problem that must be addressed when various products, including bearings and their components, are sold in the global market. Such counterfeiting can cause significant economic damage. Moreover, when the counterfeit products are made from inferior materials, much more serious problems may arise because the use of the inferior materials can create safety risks. For example, if bearing components are made from inferior materials, persons working in the vicinity of machines that use such bearing components may be endangered if the bearing component fails.

Unfortunately, counterfeits can often only be identified after time-consuming and expensive laboratory analyses. Therefore, direct and rapid detection of counterfeits, at a customer site or at trade fairs and other expositions, is not possible.

One known method for detecting counterfeit parts involves imprinting or engraving codes on the parts. However, such codes are also visible to counterfeiters and thus can be faked along with the counterfeit product itself. It has also been proposed to provide components with chips. Relevant information, such as the name of the manufacturer of the component, can be saved on the chips and read out in order to determine the authenticity of the component. However, such chips are very expensive and it may be difficult or impossible to attach them to small components. In addition, these chips may not be suitable in use in bearing products made from plastic because the chips could be damaged or destroyed by the high temperatures to which plastics are subjected while being formed into relevant bearing components. Even if not destroyed, the chips could mechanically weaken the component in which they are included and/or become points of potential failure in bearing assemblies.

### SUMMARY

The object of the present disclosure is therefore to provide a bearing element, manufactured at least partially from plastic, that is secure from counterfeiting and that can be distinguished quickly and easily from counterfeit components.

According to the disclosure a bearing element including plastic is provided, which bearing element is at least partially manufactured from a plastic or a plastic compound. The plastic or the plastic compound includes additives, in particular security particles, that are detectable analytically, in particular, that are optically detectable.

Such additives/security particles can, for example, be added directly during the compounding of the plastic, i.e., during compounding at the plastic manufacturer, or during processing, i.e., during the formation of the bearing element (e.g. by injection-molding, extruding, hot forming, winding) as an additive, compound, or masterbatch, which makes the original bearing components unambiguously identifiable and associable with a manufacturer. Such already-known security particles, available, for example, from Gerresheimer Wilden GmbH of Regensburg, Germany, can be easily detected using analytical measurement methods and can usually be added without problems to plastic mixtures. Since these security particles are easily detectable, a bearing element provided with such security particles can be clearly verified as authentic.

It is particularly advantageous if the additives are chemically and thermally stable. This allows them to be used at the expected high melting temperatures of plastics and even mixed with the plastic prior to a forming process.

According to a further advantageous exemplary embodiment, the additives comprise pigments, in particular reflective pigments. This approach allows for a particularly simple optical detection. It is particularly beneficial if the added reflective pigments reflect light at wavelengths not visible to the human eye, at infrared or ultraviolet wavelengths, for example. Such pigments have the additional advantage that they cannot be detected by the naked eye and therefore improve security because counterfeiters are less likely to become aware of the presence of this security feature.

Furthermore, in an exemplary embodiment the additive pigments comprise laser-verifiable pigments that are detectable using laser light of a certain wavelength. Like pigments that reflect at infrared and/or ultraviolet wavelengths, these pigments also cannot be seen by the naked eye, but they can easily be detected using appropriate equipment. This also provides increased security from counterfeiting for the correspondingly configured bearing elements.

According to a further advantageous embodiment, the additives are detectable using a reader, which may comprise a radiation detector, for example, a photodiode, that reacts to light of appropriate wavelengths. The reader can also include a radiation source that emits light of the wavelengths that are reflected by the reflective particles. This provides a simple way to protect against counterfeits because the reader can be delivered to the customer together with the bearing elements, or the reader can be sent to the customer before the bearing components are delivered, to allow the customer to directly and quickly verify the authenticity of purchased bearing elements when they arrive.

According to a further advantageous exemplary embodiment, the plastic is a thermoplastic and/or Duroplast and/or elastomer or comprises a thermoplastic and/or Duroplast and/or elastomer. Since bearing elements are usually manufactured from these plastics, it is particularly advantageous if the additives neither chemically nor mechanically nor thermally affect these types of plastics, so that the product properties themselves are unaffected.

It is particularly preferred to manufacture a cage for receiving rolling elements of a bearing, a seal element of a bearing, and/or a sliding layer of a sliding bearing from such plastics including counterfeit-secure additives.

Overall, the inventive bearing element provides cost-effective security against counterfeiting while being invisible to counterfeiters. Furthermore, because of the analytically simple detectability of the additives (e.g., optical detectability), the authenticity of components can be simply and rapidly verified without significant inspection effort. In addition, using the inventive bearing elements, bearing elements can be identified in a manner that is not easy (or in some cases not possible) to counterfeit. Since the identification is unique or at least unambiguous, the results of analysis may even be admissible as evidence in court.

### BRIEF DESCRIPTION OF THE DRAWINGS

These and other features and aspects of the present disclosure will become apparent after a reading of the following detailed description in connection with the attached drawings, wherein:

FIG. 1 is a schematic plan view of a bearing cage containing security particles according to an embodiment of the present disclosure.

FIG. 2 is a schematic plan view of a seal element of a bearing containing security particles according to an embodiment of the present disclosure.

FIG. 3 is a schematic plan view of a sliding layer of a sliding bearing containing security particles according to an embodiment of the present disclosure.

FIG. 4 is a schematic elevational view of a reader including a radiation source and a radiation detector next to a portion of the bearing cage of FIG. 1.

### DETAILED DESCRIPTION

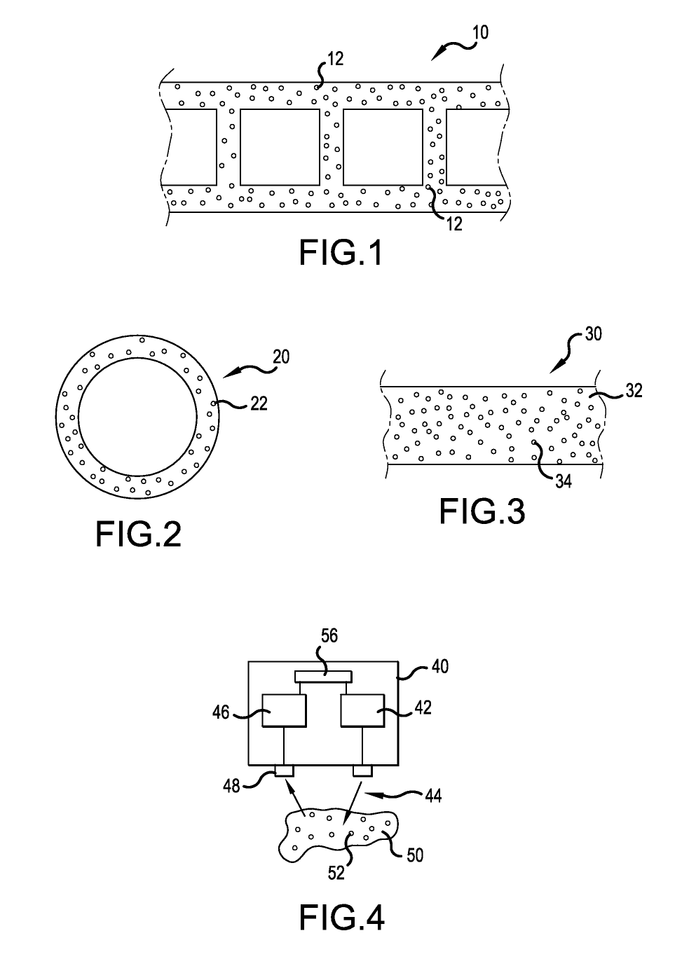

Referring now to the drawings, wherein the showings are for purposes of illustrating presently preferred embodiments of the invention only and not for limiting same, FIG. 1 illustrates a bearing cage 10 that includes security particles 12 according to an embodiment of the present disclosure. The security particles 12 are shown schematically, and the drawings are not intended to show a particular size, shape or concentration of the security particles 12. The security particles 12 are preferably not visible to the naked eye and may be configured to reflect preferentially in either the infrared or ultraviolet range.

The disclosure is not limited to a particular density of security particles; in general, the concentration of security particles should be as low as reasonably possible while still allowing the particles to be detected. Using more security particles than this may unnecessarily increase the cost of the bearing component and, if too great a density of security particles is used, the security particles could begin to affect the integrity of the finished bearing cage 10 or other bearing component.

The security particles are preferably distributed throughout the material of the bearing cage 10 even though the security particles in the interior of the bearing cage 10 will not be visible unless the bearing case is cut open to expose the interior. Such a distribution would result, for example, from mixing the security particles into the plastic material from which the bearing cage 10 is formed. Alternately, the security particles could be applied primarily to the surface of the bearing cage 10 where they are visible to reduce the amount of security particles needed.

The particles 12 have been described as being designed to “reflect” infrared and/or ultraviolet radiation. Such reflections would then be detected by a suitable detector because both the incident and reflected radiation would be invisible to the human eye. However, it is also possible to provide security particles that fluoresce or otherwise become visible, such as by emitting visible light, when illuminated by infrared and/or ultraviolet radiation.

FIG. 2 illustrates a bearing seal 20 that includes security particles 22 according to an embodiment of the disclosure.

FIG. 3 illustrates a sliding layer 30 of a sliding bearing 32 according to an embodiment of the disclosure which sliding layer 30 includes security particles 34 according to an embodiment of the disclosure.

FIG. 4 illustrates a reader 40 that includes a radiation source 42, preferably configured to emit radiation 44 in the infrared or ultraviolet range that is not visible to the human eye. The reader 40 includes a detector 46 that includes a photodiode 48. The radiation 44 is reflected from the surface of a bearing component 50 that includes security particles 52, and the reflected radiation is received by the photodiode 48.

A microprocessor 56 in the detector is configured to determine from the reflected radiation (or lack thereof) whether the bearing component 50 is authentic or counterfeit. For example, if authentic components are provided with security particles 52 designed to strongly reflect light at a particular wavelength x, the microprocessor 56 will output a signal indicative of an authentic component if a strong reflection at wavelength x is detected and output a signal indicative of a counterfeit if a weak reflection is detected. As used herein, “strong” and “weak” refer to some threshold based on how strongly a given plastic without security particles reflects at wavelength x and how strongly that plastic reflects when the security particles 52 are present.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved bearing components.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A bearing element at least partially formed from a plastic or a plastic compound and comprising additives that are detectable optically.

2. The bearing element according to claim 1, wherein the additives comprise security particles.

3. The bearing element according to claim 1, wherein the additives are chemically and thermally stable.

4. The bearing element according to claim 1, wherein the additives comprise reflective pigments.

5. The bearing element according to claim 4, wherein the reflective pigments are reflective at wavelengths not visible to the human eye.

6. The bearing element according to claim 4, wherein the additive reflective pigments are reflective at infrared or ultraviolet wavelengths.

7. The bearing element according to claim 4, wherein the pigments comprise laser-verifiable pigments that are detectable using laser light of a certain wavelength.

8. The bearing element according to claim 1, wherein the additives are detectable using a radiation detector.

9. The bearing element according to claim 8, wherein the radiation detector includes a photodiode.

10. The bearing element according to claim 1, wherein the plastic comprises a thermoplastic or a Duroplast or an elastomer.

11. The bearing element according to claim 1, wherein the bearing element is a cage for receiving rolling elements of a bearing.

12. The bearing element according to claim 1, wherein the bearing element is a seal element of a bearing.

13. The bearing element according to claim 1, wherein the bearing element is a sliding layer of a sliding bearing.

14. A plastic bearing cage comprising security particles distributed throughout a body of the bearing cage, the security particles being configured to reflect radiation at infrared or ultraviolet wavelengths.
